(19) United States
(12) Patent Application Publication
(10) Pub. No.: US 2007/0144355 A1
(43) Pub. Date: Jun. 28, 2007

(54) Methods and device for the preparation of a food product

(76) Inventors: Jean-Paul Denisart, La Conversion (CH); Patrick Caprotti, Florel/Lavauxn (CH); Jean-Luc Denisart, Cully (CH); Alex Kollep, Lutry (CH); Ruguo Hu, New Milford, CT (US); William Overbaugh, Lakeside, CT (US)

Correspondence Address: BELL, BOYD & LLOYD LLP, P.O. Box 1135, CHICAGO, IL, 60690, US

(21) Appl. No.: 10/569,531

(22) PCT Filed: Aug. 13, 2004
(86) PCT No.: PCT/EP04/09125

§ 371 Date: Jan. 30, 2007

(30) Foreign Application Priority Data
Aug. 25, 2003 (EP) 03019163.9

(51) Int. Cl. B67D 1/00

(52) U.S. Cl. 99/275

(57) ABSTRACT

The invention relates to a method for the preparation of a drink by injection of a liquid thorugh a capsule, containing a food substance which is soluble and/or for extraction, whereby the liquid is injected from at least one injection point, such as to generate a turbulent movement of injected liquid within said capsule, thus causing a brewing of the liquid with said substance.

### BACKGROUND

This invention relates to a method for preparing a beverage from a substance that is contained in a receptacle and mixed with a liquid under pressure. More specifically, the invention relates to a method whereby the substance is a soluble powder contained in an enclosure such as a capsule.

This invention also relates to a device as well as a capsule comprising an integrated injection nozzle for implementing the method according to the invention.

The use of capsules containing a substance for preparing a beverage by dispensing or mixing it under pressure is a well-established practice especially in making espresso coffee, tea or chocolate drinks and is desirable especially for reasons of hygiene, freshness, preservation and ease of use.

There are various types of machines for preparing beverages from closed or permeable capsules containing an extractable i.e. percolatable substance such as ground coffee or tea or a soluble or dispersible substance such as instant coffee, chocolate, milk or a mixture or simple combination of these substances.

The Swiss patent CH 605 293 describes a closed capsule. According to that patent, the capsule has the shape of an essentially truncated conical scoop provided with a circular flange with a welded-on metallic membrane. The membrane is equipped with a filter and the capsule holds a certain amount of the substance for brewing a beverage, typically ground coffee. When in use, the capsule is placed in an apparatus through whose centrally perforated container bottom extends an element for the pressure injection of a liquid. The liquid that is injected through the substance breaks the membrane under the effect of the pressure in such fashion that the beverage can flow through an exit opening provided in the apparatus for that purpose.

One important aspect of that process is that the liquid must flow through the entire volume of the substance contained in the capsule to obtain optimal and reproducible extraction. This is accomplished in that the injection element is in the form of a pin that is hollow in the middle and is provided near its distal end with multiple outlet holes through which water exits laterally so that the pressurized liquid can generate a fluid piston to soak to the extent possible all of the substance contained in the capsule, in this case roasted and ground coffee.

To that effect, the European patent EP 0 468 080 provides for the water exit holes to extend at an angle relative to the horizontal plane, whereby the injected water is reflected off the bottom surface before impinging on the bulk of the coffee, thus augmenting the dispersion of the water.

It is a well-known fact that the injection, mixing and steeping conditions make a considerable difference in the quality of the resulting beverage. Accordingly, for a substance that is ground and compacted in a capsule or indeed a substance that is dissolved or dispersed in a liquid, such as soluble coffee or a milk-based substance such as cappuccino, chocolate milk or the like, the manner in which the water circulates through the capsule is considered to have an effect on the extraction and mixing conditions and thus on the ultimate quality of the beverage. A product such as coffee or chocolate should thus be dissolved or dispersed quickly and completely, preferably producing a paste, whereas soluble tea should dissolve without producing any paste. The dissolution or dispersion should be total, homogeneous, quick and without forming lumps or flakes. For products that are to be extracted i.e. percolated, such as ground coffee, the optimal steeping conditions are different. The product should be completely soaked by optimizing the water/coffee contact area and without the water seeking a preferred path through the bulk of the coffee. In fact, establishing a preferred path through the bulk of the coffee can lead to an excessively strong build-up of pressure and thus to too rapid a release of the extract with not enough percolation time, while part of the coffee is still not properly saturated.

Prior-art methods and equipment are well adapted to the extraction of substances contained in a capsule, for instance roasted and ground coffee, but they are poorly adapted to capsules containing soluble substances such as powdered coffee or chocolate powder.

In fact, the design of the conventional systems for the pressure injection of liquids and the spray patterns obtained by those systems do not allow especially for the mixing effect necessary for efficaciously dissolving the soluble substance in the liquid, so that a not so negligible part of that substance fails to make contact with the liquid and is therefore not dissolved. The result is unsatisfactory reproducibility of the mixing conditions to the point where the amount of dissolved substance cannot be controlled. That in turn leads to beverages of inconsistent strength and in general to a loss of control over the quality of the beverage.

It follows from the above that there is a need for a method and a device for preparing a beverage in particular from a soluble substance contained in an enclosure.

### SUMMARY

An objective of this invention is therefore to satisfy that need by proposing a method for preparing a beverage from a soluble substance contained in an enclosure, whereby that substance is completely dissolved.

Another objective of this invention is to provide a method that is equally suitable for capsules containing a percolatable substance and for capsules containing a soluble substance.

This invention is also aimed at “open” beverage brewing devices, i.e. those whose mixing and/or percolation chamber, strictly speaking, is not a capsule but a chamber that is a part of the device itself.

Another objective of this invention is to provide a method for preparing a beverage from either a percolatable or a soluble substance contained in an enclosure that is easy and inexpensive to make.

Yet another objective of the invention is to introduce a device for preparing a beverage by the method per this invention.

The invention further introduces a capsule by means of which the method per this invention can be implemented.

To that effect, the invention introduces a method for preparing a beverage whereby a liquid is injected through a receptacle, containing a soluble and/or percolatable alimentary substance, from at least one injection point in such fashion as to generate within the said receptacle a turbulence of the injected liquid, causing the liquid to mix with the said substance.

In one preferred form of implementation of the invention, the liquid is injected at a distance from the center of the receptacle, whereby the jet spray of liquid is directed past that center, thus generating a turbulent movement around the said center of the receptacle. Additionally, the jet is suitably inclined toward the bottom wall of the receptacle.

In this fashion a turbulence can be created within the receptacle that ensures homogeneous mixing of the substance in the receptacle with the injected liquid, thus leaving no solid residue of the substance in the receptacle. In fact, the injected liquid can move more freely within the receptacle by multiple reflection of the swirling spray off the receptacle walls, thus reaching all of the substance, quickly penetrating the latter. This method thus promotes the dissolution of “soluble” substances such as instant coffee or “dispersible” substances such as chocolate powder while eliminating pockets of accumulated residual solids that tend to form both on the bottom and along internal ridges and rims of the receptacle.

This process thus lends itself to the preparation of beverages for instance from identical capsules in which the concentration of the percolated or dissolved substance varies very little from one capsule to the next.

Another advantage lies in the fact that, as the soluble substance is mixed with the injected liquid, air is trapped in the mixture, whereby a frothy beverage can be produced.

A further advantage is the simplicity and ease of implementing this process.

Yet another advantage of this method is that it can be used with a large variety of alimentary products.

One objective of the invention is a device for preparing a beverage by injecting a liquid through a capsule containing an alimentary substance to be dissolved or extracted, said device comprising means for holding the capsule and at least one liquid-injection assembly designed to inject the liquid in the form of ajet spray from at least one injection point inside the capsule, characterized in that the injection point and the direction of the jet spray are configured in a way as to create in the capsule a swirling turbulence that causes the liquid to mix with the substance.

Another objective of the invention is a capsule containing a soluble and/or percolatable alimentary substance for preparing a beverage by the injection of a liquid under pressure generated by an external apparatus, said capsule incorporating an upper and a lower wall connected by a lateral wall so as to define a chamber in which the said substance is contained, the capsule being characterized in that the upper wall encompasses an injection assembly designed to inject the liquid in the form of a jet spray into the chamber from at least one injection point, said injection point and the direction of the jet spray being so configured as to create in the capsule a swirling turbulence that causes the liquid to mix with the substance.

By virtue of these characteristics the capsule permits the implementation of the method per this invention with a device of the conventional type with a simple liquid-dispensing nozzle.

In one preferred form of implementation of the capsule according to the invention, the upper wall encompasses an outer wall section and an inner wall section, together delimiting a cavity that is sealed against the outside and designed to accommodate a perforation and injection element as well as a channel connecting said cavity with the injection assembly.

In that design version the injection assembly preferably includes a nozzle that is integrated in the inner wall section. The cavity and the channel are advantageously formed into the inner wall while the outer wall is constituted of a perforatable membrane. The cavity is preferably situated essentially in the center of the capsule.

Other features and advantages of this invention will be evident from the following description of a non-limiting example of a preferred form of implementation of the method and the device per the invention, with reference to the attached diagrams.

Additional features and advantages are described herein, and will be apparent from, the following Detailed Description and the figures

### BRIEF DESCRIPTION OF THE FIGURES

FIG. 1 is a schematic sectional view of a first form of implementation of a device, shown in its open position, for brewing a beverage by the injection of a liquid through a capsule according to the invention;

FIG. 2 is a schematic sectional view of the brewing device per FIG. 1, shown in its closed position;

FIG. 3 is a schematic top view of a capsule, illustrating in particular the location of the liquid-injection point in the latter, with the cover left off;

FIG. 4 is a diagrammatic perspective view of a perforation and injection element mounted on the device per this invention as shown in FIG. 1;

FIG. 5 is a diagrammatic perspective view of a design variation of the device for brewing a beverage by injecting a liquid through a capsule per this invention, with the capsule holder left off;

FIG. 6 is a schematic sectional view of a second form of implementation of a device for brewing a beverage by injecting a liquid through a capsule per this invention, with the device shown in its closed state and in a first functional mode;

FIG. 7 is a schematic view of the brewing device per FIG. 6, shown in its closed state and in a second functional mode;

FIG. 8 a and 8 b are schematic perspective and, respectively, perspective-section views of the perforation and injection element for use in combination with the second form of implementation of the brewing device;

FIG. 9 a and 9 b are schematic perspective and, respectively, perspective-section views of a design variation of the perforation and injection element for use in combination with the second form of implementation of the device;

FIG. 10 is a schematic perspective section and partly cut-away view of a capsule per this invention; and

FIG. 11 is a schematic perspective detail illustration of the capsule per FIG. 10.

For the purpose of the following description, identical components in the diagrams bear identical reference numbers.

### DETAILED DESCRIPTION

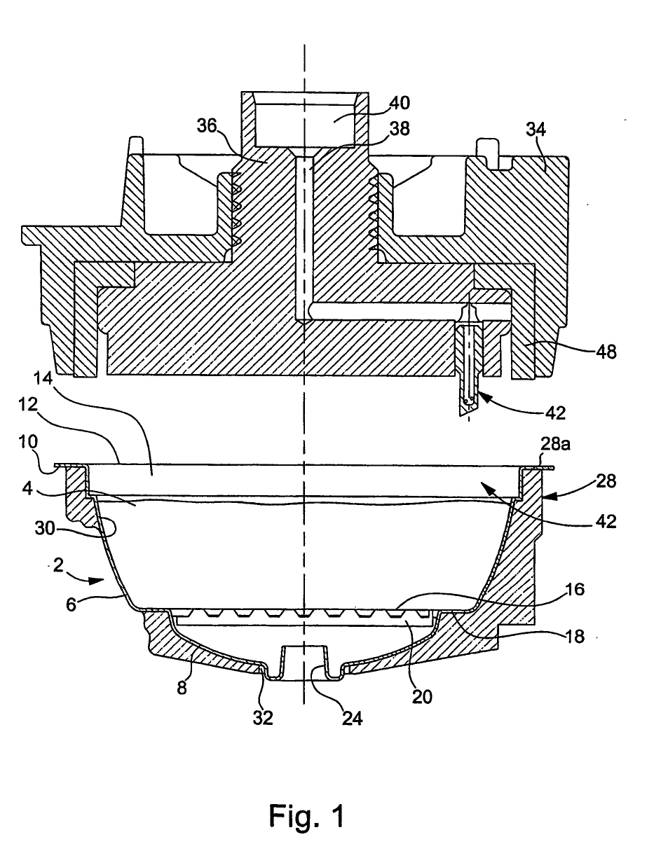

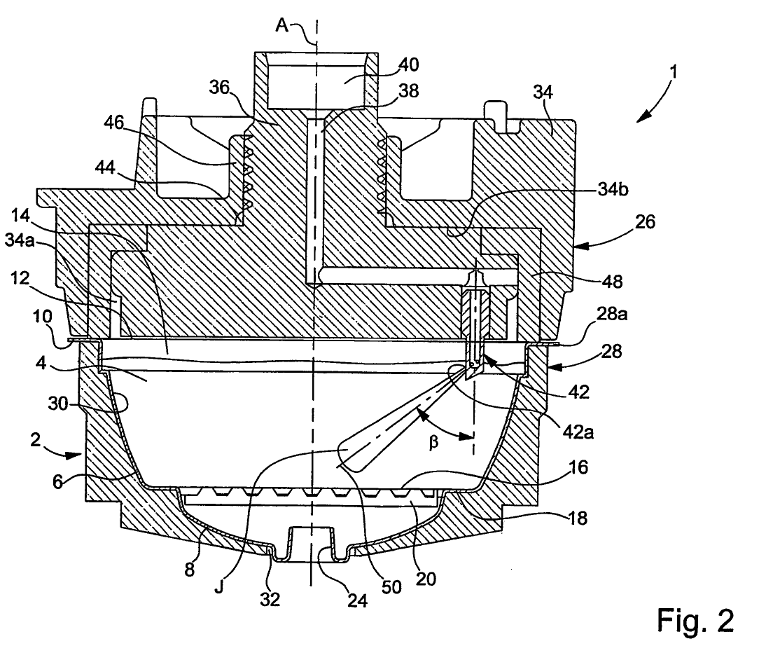

FIG. 1 and 2 show a device 1 for brewing a beverage, open in FIG. 1 and closed for operation in FIG. 2. In the device 1, the beverage is prepared by pressure-injecting a liquid, typically hot or cold water, through a capsule 2 containing a soluble and/or percolatable alimentary substance 4 (not shown), such as roasted ground coffee, or tea, soluble coffee, a mixture of ground and soluble coffee, a chocolate product or any other dehydrated alimentary substance.

As can also be seen in FIG. 1, the capsule 2 is essentially in the form of a small cup with a lateral wall 6 and a lower wall 8 defining the bottom. In the example illustrated, the diameter of the bottom 8 is smaller than the diameter of the mouth of the cup. The free end of the lateral wall 6 terminates in an essentially annular peripheral rim 10 that extends toward the outside of the cup. The lateral wall 6 and the bottom 8 would typically consist for instance of a single- or multi-layered plastic material selected from among the group that includes EVOH, PVDC, PP, PE, PA .The cup is hermetically sealed off by an upper wall 12 constituted of a cover that is mounted on the rim 10 for instance by thermal bonding. The cover 12 is typically made of a material that can be pierced by perforation and injection elements, described in detail below, of the device 1. The material of the cover 12 could be selected for instance from the group including aluminum, an aluminum/plastic compound, a cardboard/plastic composition, a cardboard/aluminum/plastic combination, plain or multi-layered plastic. Together, the side wall 6, the bottom 8 and the cover 12 thus form a chamber 14 that contains the alimentary substance 4. Of course, the capsule 2 may equally well be an open or partly open capsule. In a more general sense, the term “capsule” broadly refers to any replaceable type of container that encloses a substance without limitation as to its shape or constituent materials.

In the example illustrated it can be seen that the capsule 2 incorporates in its lower segment a thin film 16 sealed onto an inner rim 18 of the cup and closing off the lower part of the chamber 14. That thin film 16 sits on top of a disc 20 featuring on its upper surface multiple evenly spaced protrusions that form multiple channels leading to the perimeter of the disc and into a collection chamber 22 which is delimited by the disc 20 and the bottom 8 and itself opens up to the outside via an exit port 24. The thin film 16 will break on contact with the protrusions under the pressure load inside the chamber 14. As can be seen, the exit port is integral to the capsule 2, the advantage of which is that it permits the direct delivery of a product into a drinking cup without direct contact with the device, ensuring the absence of any beverage cross-contamination, better hygiene, less cleaning, and greater design simplicity even of the device itself. For a more detailed description of the capsule 2, reference is made to the European patent application PCT No. 03/00384 filed on Jan. 13, 2003 in the name of this claimant and whose entire content is made a part hereof by reference.

The device 1 incorporates a generally cylindrical liquid-injection head 26 situated on a generally cylindrical capsule holder 28. The injection head 26 and the capsule holder 28 can be vertically moved relative to each other between the open position (FIG. 1) in which the capsule 2 can be placed on the capsule holder 28 and the closed position (FIG. 2) in which the device 1 can be activated.

More precisely, the capsule 2 is placed in a retainer 30 in the capsule holder, the shape of which typically matches in complementary fashion that of the capsule to be accommodated. In its lower section the retainer 30 is provided with an opening 32 that lines up with the exit port 24 of the capsule 2. The capsule holder thus constitutes the support for the capsule 2 in the device 1.

The injection head 26 includes an essentially bell-shaped support 34 in whose throat 34 a a core shaft 36 is mounted. The latter comprises a liquid-intake channel 38 that extends between a liquid-input well 40 and a perforation and injection element 42 with an injection port 42 a. The perforation and injection element, described below in detail, serves to pass through the cover 12 so as to connect the injection port 42 a with the inside of the capsule upon the relative movement of the injection head 26 and the capsule holder 28 that puts the brewing device in the closed position.

The well 40 is designed to connect to a liquid feeder tube from an apparatus (not shown) capable of supplying hot or cold liquid under pressure. The injection head 26 thus constitutes an injection assembly that can inject a liquid in the form of ajet spray J from at least one injection point defined by the injection port 42 a of the perforation and injection element 42.

In the example shown, the throat 34 a is essentially cylindrical and its base 34 b features a central opening 44 that extends axially toward the outside through a sleeve 46 with an internal thread.

The core shaft 36 includes a first cylindrical, large-diameter segment that extends in the throat 34 a and a second segment with a smaller diameter that screws into the sleeve 46. The injection head 26 also comprises an annular gasket 48 interpositioned between the first segment of the core shaft 36 and the inner side wall of the throat 34 a. The gasket 48 is so placed that, in the closed position (FIG. 2) it presses against the rim 10 of the capsule which in turn sits on an upper peripheral support surface 28 a of the capsule holder 28. The gasket 48 also projects axially from the throat 34 a, allowing it to be appropriately compressed when it makes contact with the rim 10, thus ensuring a good seal. In the example shown, it can be seen that the gasket 48 also seals off the intake channel 38 in the area of the perforation and injection element 42.

Referring to FIG. 3, which is a top view of the capsule 2 with the cover 12 left off and in which only the perforation and injection element 42 of the injection head 26 is shown, it can be seen that the perforation and injection element 42 and more specifically its injection port 42 a is situated at a distance from the center C of the capsule 2 and is thus off center relative to its vertical axis A-A. The axis 50 of the injection port 42 a is oriented at one end in a first direction that passes by the center C (FIG. 3) of the capsule 2 and at the other end in a second direction oriented toward the bottom of the latter (FIG. 2). With this positional configuration of the injection port 42 a in the capsule and the particular orientation of the axis 50 of that port, the injection of a liquid produces a jet spray J that creates in the capsule a swirling turbulence of the liquid around the center C of the capsule, with concurrent, multiple jet-spray reflections off its inner walls. The general swirling movement of the injected liquid in combination with its multiple reflections leads to a thorough mixing of the liquid with, and complete saturation of, the substance 4.

To obtain that mixing result, i.e. to create in the capsule 2 an optimal vortex effect, the claimant has found that part of the axis 50 of the injection port 42 a has to be at an angle α of between 20° and 60°, and preferably between 35 and 45°, relative to the line 52 that connects the injection point with the center C of the capsule 2, and that the axis 50 has to be at an angle β of between 50° and 70°, and preferably between 55 and 65°, relative to the vertical axis A-A of the capsule. It was also found that the injection port 42 a should preferably be located near the side wall 6 of the capsule so as to be able to progressively moisten the substance from the perimeter of the capsule towards its center, ensuring that all of the substance comes in contact with the liquid. As an example, the diameter of the injection port 42 a is about 0.7 mm, the rate at which the liquid is injected is about 4 ml/s.

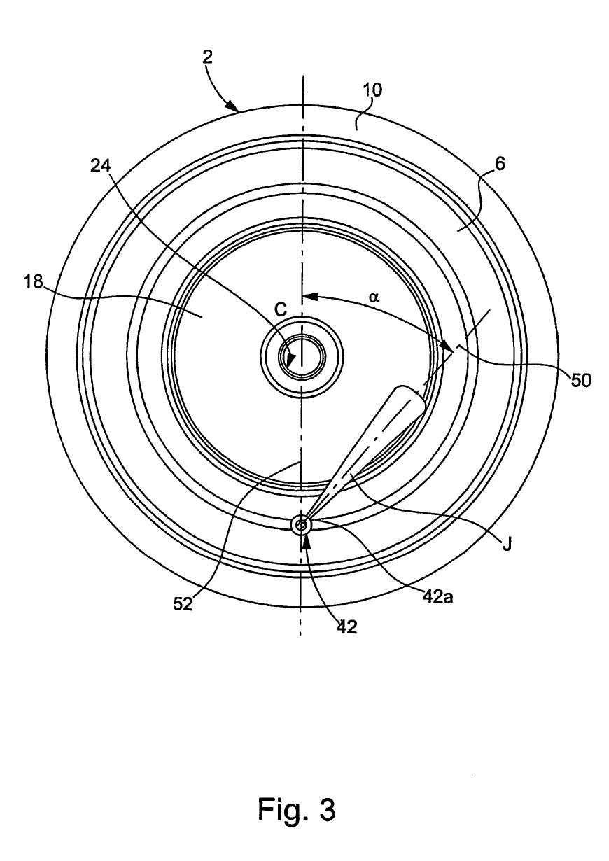

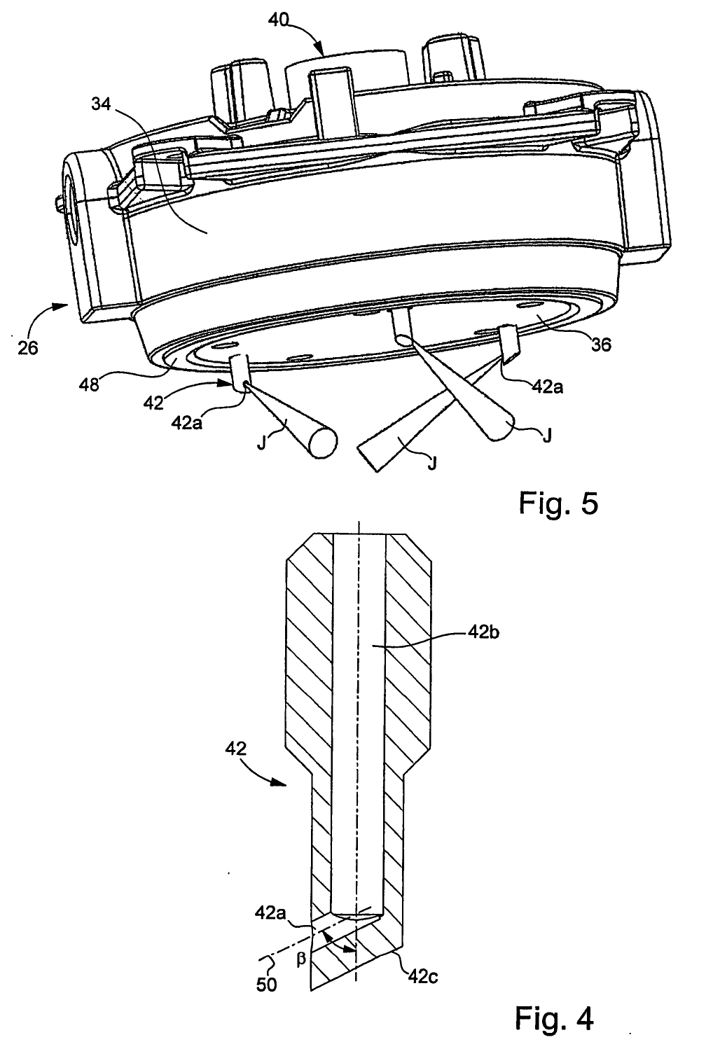

FIG. 4 is a section view of an implementation example of the perforation and injection element 42, which serves the purpose of piercing and extending through the cover 12 when the brewing device is in its closed position. The perforation and injection element 42 includes a hollow pin with a channel 42 b that is open at both ends. The first end connects to the intake channel 38 as the second end leads to the outside through the injection port 42 a. The channel 42 b contains a first rectilinear segment that is extended by a second segment which terminates in the injection port 42 a and forms an angle with the first segment. The slope of the second segment of the channel is identical to the angle at which the liquid is injected into the capsule, with the first segment extending essentially parallel to the axis A-A when the pin is positioned in the core shaft 36. It can also be seen in FIG. 4 that the hollow pin that constitutes the perforation and injection element 42 features a bevel 42 c at its distal end and that the injection port 42 a leads to a surface opposite the bevel 42 c. That particular configuration of the distal end of the pin advantageously allows the pierced section of the cover 12 a to be pushed toward the opposite side away from the injection port when the pin 42 punches through the cover 12, so that the injection port is always completely free and that section of the cover 12 a does not interfere with the injection of the liquid into the capsule.

According to one design variation, not illustrated, a seal may be provided around the perforation and injection element 42 to keep the chamber sealed off from the outside when the brewing device is in the operating state.

Of course, the location of the injection port 42 a is such that the injection of the liquid takes place a few millimeters below the cover 12, typically 4 mm.

FIG. 5 is a perspective diagram of a design variant of the device 1 for brewing a beverage by injecting a liquid through a capsule per this invention, showing only the injection head. In that design variation the capsule holder is identical to that described above in reference to FIG. 1 and 2, while the injection head 26 comprises not only one single perforation and injection element 42 but several, in this case 3, all identical in design and identical in their orientation to the perforation and injection element 42 described in connection with FIG. 1 to 4. As can be seen, the three perforation and injection elements 42 are evenly spaced apart on a lower surface of the injection head 26, serving to act on the cover 12 of the capsule 2 when the brewing device is in the operating state. Typically, these elements 42 are spaced apart 120° from one another around the center of the injection head 26. In this case the intake channel 38 is, of course, designed to connect to each of the three perforation and injection elements 42.

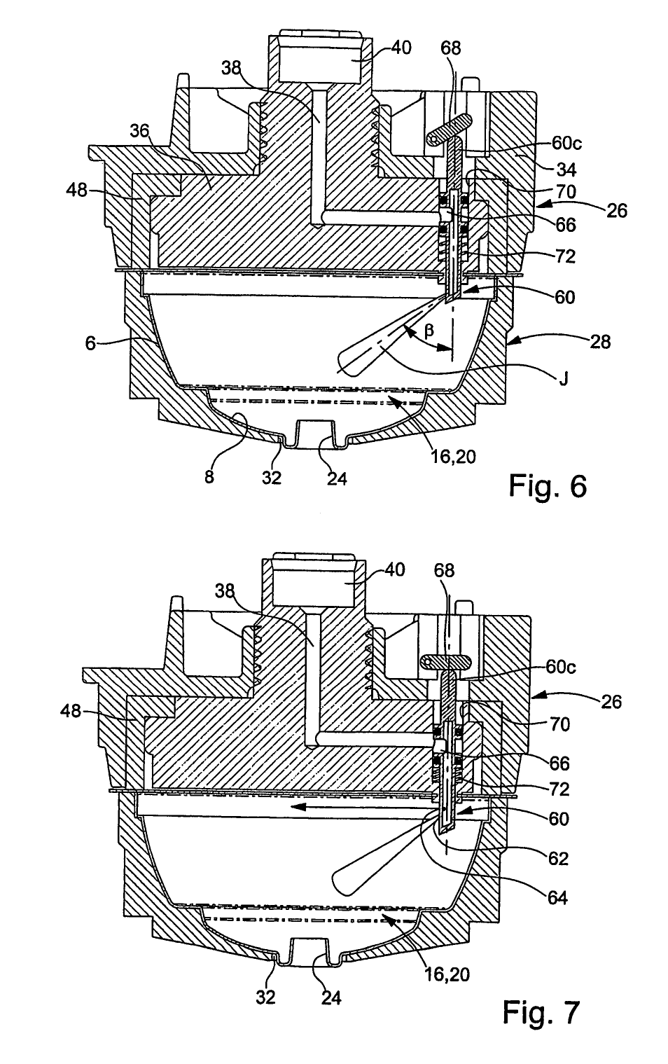

FIG. 6 and 7 depict a second form of implementation of a device for preparing a beverage by injecting a liquid through a capsule according to this invention. The brewing device is shown in its closed position in both figures but in a first functional mode in FIG. 6 and in a second functional mode in FIG. 7. For the purpose of this invention, the term functional mode refers to the desired way in which the substance contained in the capsule 2 is to be wetted, that mode essentially depending on the type of substance used.

FIG. 6 shows the brewing device in a first wetting mode whereby the liquid is injected into the capsule in a way as to create a swirling movement of the liquid around the center C of the capsule in combination with multiple reflections of the jet spray off its inner walls, as described in reference to FIG. 1 and 2. This saturation mode is best suited to capsules containing soluble substances since it permits the complete and rapid dissolution of substances of that nature.

FIG. 7 shows the brewing device in a second wetting mode whereby the liquid is injected into the capsule in a way that, in addition to the swirling turbulence of the liquid around the center C of the capsule, the upper part of the capsule is soaked with the aid of a jet that diverts some of the liquid in the form of a fine sheet, wetting the substance in the capsule from above. That saturation mode is particularly useful in capsules containing percolatable substances since it permits the complete and rapid dissolution [sic] of that type of substances.

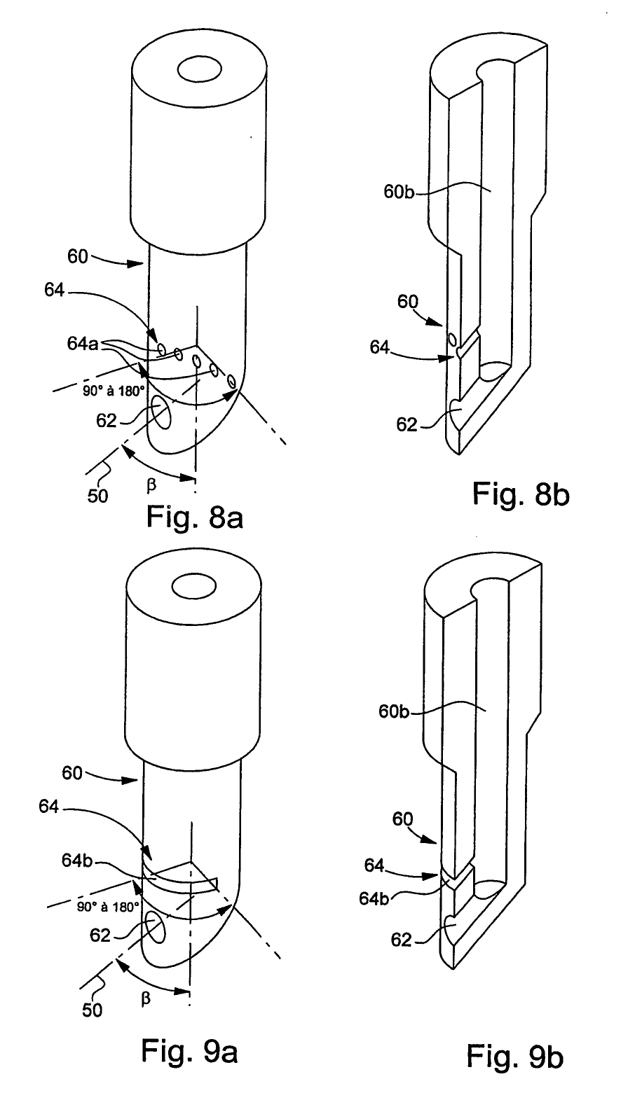

According to this second form of implementation of the invention, the brewing device comprises a perforation and injection element 60 with a first injection port 62 positioned and oriented in the same way as the injection port 42 a of the perforation and injection element 42 described in reference to FIG. 1 to 4, and a second injection unit 64 whose injection axis extends in essentially horizontal fashion to produce that divergent stream in the form of a fine sheet of liquid. In both FIGS. 8 a and 8 b it can be seen that, in the example illustrated, the perforation and injection element 60 is in the form of a hollow pin with a channel 60 b that leads outside to a first end by way of the first and second injection units 62 and 64, respectively. The channel 60 b also connects to the intake channel 38 in its median section through an opening 66. The perforation and injection element extends at the end opposite the injection units 62 and 64 into a cam 60 c that interacts with a lever 68 controlled by switching elements (not shown) connected to the head 26. The perforation and injection element 62 includes in its middle part a segment with a larger diameter, in which the opening 66 is located and by which it is mounted so as to permit translatory movement in a shoulder-equipped track 70 that extends parallel to the vertical axis of the injection head set in the core shaft 36, with a pullback spring 72 positioned between the bottom of the track and one shoulder of the perforation and injection element 62. Two O-ring gaskets are located on either side of the opening 66 on the perforation and injection element 60, making contact with the inner surface of the track 70.

In this form of implementation the perforation element 60 can move between two distinct positions, i.e. one first position (FIG. 6) in which only the first port 62 connects to the inside of the capsule 2 and which corresponds to the first wetting mode, and a second position (FIG. 7) in which the first port 62 and the second injection unit 64 connect to the inside of the capsule 2 and which corresponds to the second wetting mode. The switchover from the first wetting mode to the second wetting mode is accomplished via the switching elements that shift the perforation and injection element 60 under the action of the pullback spring 72 by way of the lever 68. Of course, the diameter of the intake channel 38 and that of the opening 66 and the path of the perforation and injection element for shifting from the first to the second wetting mode are such that the opening 66 is at all times at least partially connected to the intake channel 38 regardless of the wetting mode selected.

Preferably, and as is evident from FIG. 8 a and 8 b, the second injection unit 64 by means of which a divergent stream in the form of a fine sheet of liquid is produced, contains several ports 64 a, distributed around part of the perimeter of the perforation and injection element 60. While the perforation and injection element 60 is located off-center inside the capsule, and more specifically near the side wall of the latter, the ports 64 a are aimed toward the center of the capsule. For reasons that have to do with the fabrication of the element 60, the ports 64 a are advantageously staggered in height relative to one another. These ports 64 a produce several diverging streams that combine to form a fine sheet of liquid that soaks and saturates the substance contained in the upper part of the capsule.

Of course, that fine sheet of liquid could just as conceivably be produced by a single port 64 b in the form of a slit extending transversely in the longitudinal direction of the element 60 as shown in FIG. 9 a and 9 b. In that case the diverging stream is spread over a circular area large enough to soak essentially all of the substance in the upper part of the capsule.

As will be evident, the ports 64 a and the port 64 b are respectively positioned in a way as to produce an essentially continuous fine sheet of liquid over an angular sector of between 90° and 180° and preferably about 160°. Moreover, these ports 64 a and 64 b are designed to produce a sheet of liquid having a thickness of less than or equal to 0.5 mm and preferably less than 0.3 mm. To that effect, the diameter selected for the ports 64 a is preferably about 0.5 mm while the diameter selected for the port 64 b is about 0.7 mm.

In an advantageous variation of the second form of implementation, the axis of the second injection units 64, i.e. the axis of the ports 64 a and 64 b, respectively, that defines the direction of the liquid spray, forms an angle of between 0° and 25° and preferably an angle of about 15° with the horizontal plane. The liquid that is injected by these ports is thus directed upward and is first reflected off the lower surface of the cover 12, then sent back in a second step toward the bulk of the substance in substantially more dispersed form, further improving homogeneous saturation of the substance.

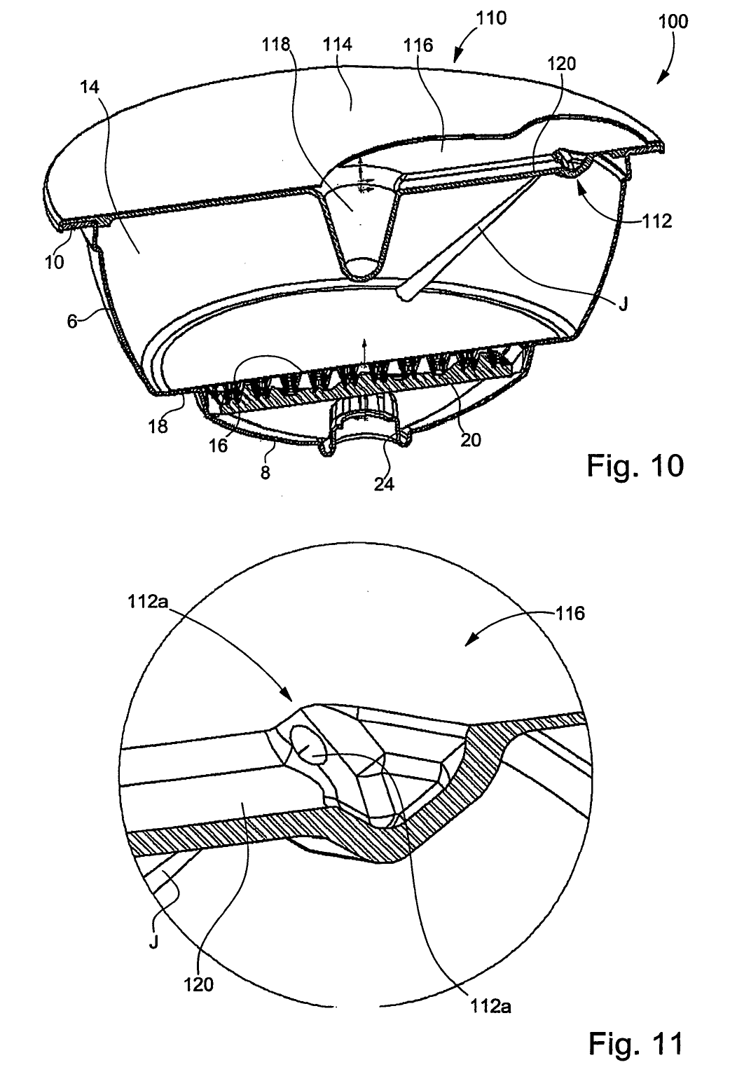

FIG. 10 shows a capsule 100 that contains a soluble and/or percolatable alimentary substance 4 for brewing a beverage by injecting a pressurized liquid and which is suitable for implementing the method per this invention with a conventional device equipped with a single liquid distribution nozzle. To that effect the capsule 100 differs from the capsule 2 described in reference to FIG. 1 and 2 in that the upper wall 110 comprises an injection assembly 112 so configured as to inject liquid into the chamber 14 from one jet-type injection point J, with the injection point and the direction of the said jet spray J being so chosen as to create in the said capsule a swirling turbulence, causing the liquid to mix with the said substance.

More specifically, the upper wall 110 encompasses an outer wall element 114 and an inner wall element 116, which together define a cavity 118 that is sealed off against the outside, as well as a channel 120 that connects the cavity 118 with the injection assembly 112.

The outer wall element 114 is in the form of a cover comprising at least one region of a material that can be pierced by a perforation and injection element (not shown) such as the injection nozzle of a conventional beverage-brewing device. In the example illustrated, the outer wall element 114 is a cover thermobonded onto the rim of the capsule, with the structure of this cover being identical to that of the cover 12 described in connection with FIG. 1 and 2.

In this form of implementation the cavity 118 and the channel 120 are directly recessed at specific depth levels into the inner wall element 116, with the cavity 118 produced essentially in the center of the capsule. Since the cavity 118 is designed to receive the perforation and injection element of a conventional brewing device, its location and depth could of course vary as a function of the device with which it is to be used.

The inner wall element 116 also encompasses the injection assembly 112 constituted of an injection nozzle 112 a. Preferably, and as illustrated, the injection nozzle 112 a is an integral part of the inner wall element 116. The injection nozzle 112 a includes an injection port 112 b that is positioned and oriented in the same way as the injection port 42 a of the perforation and injection element 42 described in reference to FIG. 1 to 4.

In a design variation, not shown, of the capsule according to this invention, the injection nozzle may also comprise second injection elements whose injection axis extends in an essentially horizontal direction, producing a second diverging stream in the form of a fine sheet of liquid. These second injection elements could typically be constituted of multiple ports or of a slit as described above in reference to FIG. 8 a and 9 a.

The following describes the method per this invention for brewing a beverage by injecting a liquid through a capsule containing a soluble alimentary substance, employing the first form of implementation of the device per the invention as illustrated in FIG. 1 and 2. First, the capsule 2 is placed in the capsule holder 28 while the device is in its open position (FIG. 1). Next, the device is closed with a relative vertical movement of the capsule holder 28 and of the injection head 26 (FIG. 2). That clamps the rim 10 of the capsule between the lower annular surface of the gasket 48 and the upper perimeter of the support 28 a of the capsule holder. At the same time the cover 12 is pierced by the perforation and injection element 42. In that configuration the injection port 42 is situated inside the capsule 2, preferably several millimeters below the cover. The liquid used for brewing the beverage, for instance hot water, is then pressure-injected in the capsule through the port 42 a so oriented as to lead in a first step to the progressive dissolution of the substance to be dissolved, in a direction past the center as well as at an angle toward one wall of the capsule, digging a tunnel up to that wall of the capsule 2. Having reached that wall, and given the orientation of the jet spray and its kinetic energy, the spray is deviated and continues to dissolve the substance in another direction until it is again shifted toward another wall, thus creating a swirling movement of the injected liquid around the center of the capsule. That swirling turbulence thus mixes the liquid with the substance, permitting thorough dissolution of the latter. At the same time, the pressure inside the capsule rises slowly, progressively dilating the membrane around the protrusions on the disc 20 illustrated in the examples per FIG. 1 and 2. As soon as the breaking tension of the membrane 16 is reached as a result of the pressure, the membrane bursts and the dissolved liquid can run out through the exit port 24 of the capsule 2. The swirling jet continues its multiple reflections so as to reach the remaining amounts of the substance until these are completely dissolved.

In preparing a beverage by injecting a liquid through a capsule that contains an extraction-type i.e. percolatable alimentary substance by employing the second form of implementation of the device per the invention as illustrated in FIG. 6 and 7, the method according to the invention differs from that described above in that the device is first switched into the wetting mode that corresponds to the substance contained in the capsule, in this case the second wetting mode illustrated in FIG. 7. That wetting mode additionally triggers an injection of liquid in the upper part of the capsule in the form of one or several fine sheets of liquid for wetting the substance from above via the injection units 64. The claimant has found that wetting the substance with a combination of the jet spray J and the fine sheet of liquid is particularly effective especially in brewing beverages from percolatable substances.

It can be seen that with a capsule 100 as shown in FIG. 10, a device equipped with a conventional perforation and injection element can be used to employ the brewing method according to the invention. Indeed, all that is needed is for the position of the cavity 118 to be aligned with the perforation and injection element of the device when the capsule 100 is situated in the device so that at the moment that the cover 110 is pierced the perforation and injection element can penetrate into the cavity 118. At that point the injected liquid fills the cavity and is then channeled via the channel 120 to the injection port 112a where it is injected under pressure into the capsule, leading to the events described above.

course, this invention is not limited to the forms of implementation described above, and it will be understood that various modifications and/or enhancements that are obvious to those skilled in the art can be made without departing from the essence of the invention as defined in the attached claims. In particular, as far as variants are concerned, one could envision a design in which the perforation takes place not through the cover 12 but through other walls of the capsule, so long as the perforation element is so located and oriented as to cause the injected liquid spray to generate a swirling movement around the center C of the capsule, permitting the liquid to mix with the substance contained in the capsule. For example, the perforation and injection element could pass through the side wall or even through the bottom of the capsule.

Abbreviations

EVOH: copolymer of ethylene and vinyl alcohol

PVDC: Vinylidene polychloride

PP: Polypropylene

PE: Polyethylene

PA: Polyamide

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. Method for preparing a beverage by injecting a liquid into an enclosure containing an alimentary substance, comprising the steps of injecting liquid from at least one injection point in a manner as to create in the enclosure a swirling movement of the injected liquid, thus causing said liquid to mix with said substance.

2. Method as in claim 1, in which the enclosure comprises a center and the liquid is injected at a distance from the center of the enclosure, the injected liquid being in the form of a jet spray that is directed past said center in such fashion that a swirling movement around the center of the enclosure is obtained.

3. Method as in claim 2, in which the enclosure has an essentially vertical axis and in which the said jet spray is also angled downward.

4. Method as in claim 2, in which the direction of the jet spray from the injection point forms an angle of between 20° and 60° relative to a line that connects the injection point and the center of the enclosure.

5. Method as in claim 2, in which the direction of the jet spray forms an angle of between 50° and 70° relative to the vertical axis of the enclosure.

6. Method as in claim 2, whereby the liquid is injected from multiple injection points evenly spaced apart within the enclosure.

7. Method as in claim 1 wherein the enclosure is a capsule.

8. Method as in claim 7, wherein the capsule comprises an upper wall and a lower wall, connected by a lateral wall, and in which the injection of the liquid takes place near the lateral wall of the capsule.

9. Method as in claim 8, in which the injection takes place through the upper wall of the capsule.

10. Method as in claim 8, in which the injection point is located at a distance of about 4 mm from the said upper wall.

11. Method as in claim 7, comprising the step of selectively providing an additional injection of liquid into the upper part of the capsule in the form of one or several fine sheets of liquid for wetting from above the said alimentary substance contained in the capsule.

12. Method as in claim 1, in which the enclosure is a mixing bowl that is part of a device for brewing beverages.

13. Device for preparing a beverage by injecting a liquid through a capsule containing a substance to be dissolved or extracted, said device having a support for said capsule and at least one liquid-injection assembly designed to inject the liquid in the form of a jet spray from at least one injection point into the interior of the capsule, the injection point and the direction of the jet spray are configured in a manner as to create in said capsule a swirling turbulence that causes the said liquid and the substance to mix.

14. Device as in claim 13, in which the capsule comprises a center and in which the injection assembly includes at least one perforation and injection element with a first injection port, the first injection port is situated at a distance from the center of the capsule and that the axis of that first injection port extends along a direction past said center.

15. Device as in claim 14, wherein the axis of the injection port from the injection point forms an angle of between 20° and 60° relative to a line that connects the injection point and the center of the capsule.

16. Device as in claim 13 wherein the capsule has an essentially vertical axis and the axis of the first injection port also extends downward.

17. Device as in one of the claim 14 wherein the axis of the first injection port forms an angle of between 50° and 70° relative to the vertical axis of the capsule.

18. Device as in one of the claim 13, comprising multiple perforation and injection elements evenly spaced apart within the capsule.

19. Device as in claim 13 wherein the perforation and injection element is selected from the group consisting of a point, a leaf, a blade, and a needle.

20. Device as in claim 13 wherein the perforation and injection element is a pin with a bevel in its distal region and that the injection point is positioned opposite that bevel.

21. Device as in claim 13 wherein the perforation and injection element also includes at least one second injection port whose axis extends in an essentially horizontal direction to produce a second diverging jet stream in the form of a fine sheet of liquid.

22. Device as in claim 13 wherein the perforation and injection element comprises multiple second ports distributed along the perimeter of the perforation element for producing multiple jet sprays that combine to form a fine sheet of liquid.

23. Device as in claim 21 wherein the axis of the second injection port forms an angle of between 0° and 25° relative to the horizontal plane and that the fine sheet of liquid extends in essentially continuous fashion over an angular sector of about 160° and that the fine sheet of liquid has a thickness of less than or equal to 0.5 mm.

24. Device as in claim 21 comprising means which, in response to control elements, permit the obturation of the second injection port(s) for switching the device between at least two different substance-wetting modes.

25. Capsule containing a soluble and/or extractable alimentary substance for brewing a beverage by injecting a liquid under pressure, encompassing an upper wall and a lower wall, connected by a lateral wall to define a chamber in which the substance is contained, the upper wall encompasses an injection assembly configured to inject said liquid in the form of a jet spray into the chamber from at least one injection point, with the injection point and the direction of the jet spray being so constructed and arranged to create in the capsule a swirling movement that causes the said liquid to mix with the said substance.

26. Capsule as in claim 25 wherein the upper wall encompasses an outer wall element and an inner wall element together delimiting a cavity that is sealed against the outside and designed to receive a perforation and injection element, and a channel connecting said cavity to the injection assembly.

27. Capsule as in claim 25 wherein the injection assembly includes a nozzle that is an integral part of the inner wall.

28. Capsule as in claim 25 wherein the cavity and the channel are formed into the inner wall element.

29. Capsule as in claim 25 wherein the outer wall element is constituted of a perforatable membrane.

30. Capsule as in claim 27 wherein the nozzle includes a first injection port, the injection port is positioned at a distance from the center of the capsule and that the axis of the said first injection port extends in a direction past that center.

31. Capsule as in claim 25 wherein the capsule has an essentially vertical axis, the axis of the said first injection port also extends downward.

32. Capsule as in claim 27 wherein the nozzle also includes at least one second injection port whose axis extends in an essentially horizontal direction to produce a second diverging jet spray in the form of a fine sheet of liquid.

33. Capsule as in claim 27 wherein the nozzle comprises multiple second ports distributed along its perimeter for producing multiple jet sprays that combine to form a fine sheet of liquid.

34. Device for preparing a beverage by injecting a liquid through a capsule containing a substance, the device comprising at least one liquid-injection assembly designed to inject the liquid in the form of a jet spray from at least one injection point into the interior of the capsule, the injection point and the direction of the said jet spray are configured so as to create in the capsule a swirling turbulence that causes the liquid and the substance to mix.
